(19) United States
(12) Patent Application Publication
(10) Pub. No.: US 2014/0312030 A1
(43) Pub. Date: Oct. 23, 2014

(54) Microwave heat treatment apparatus and method

(71) Applicants: Paul D. Steneck, Knoxville, TN (US); Michael J. Smith, Knoxville, TN (US); Larry E. Stokely, Lenoir City, TN (US)

(72) Inventors: Paul D. Steneck, Knoxville, TN (US); Michael J. Smith, Knoxville, TN (US); Larry E. Stokely, Lenoir City, TN (US)

(21) Appl. No.: 13/986,350

(22) Filed: Apr. 23, 2013

(51) Int. Cl. H05B 6/64; H05B 6/78

(52) U.S. Cl. CPC H05B 6/6473; H05B 6/6491; H05B 6/78
USPC 219/681; 219/686; 219/759

(57) ABSTRACT

A heat treating system comprises a hot-wall microwave applicator cavity having a gas-diffusing structure on one surface, a microwave power supply, a transmission line between the applicator and power supply, and a granular heat transfer medium partially filling the cavity. The medium may be a single material or a blend of several materials, preferably having equivalent aerodynamic densities. The related method includes the steps of: placing a material to be heated into a microwave cavity having a gas diffusing structure on one surface; partially filling the cavity with a quantity of granular heat transfer medium sufficient to cover the material to be treated and the gas diffusing structure; flowing gas through the diffusing structure at a rate sufficient to fluidize the granular medium; and, introducing microwave energy into the cavity to raise the material and granular medium to a selected temperature for a selected time.

### BACKGROUND OF THE INVENTION

1. Field of the Invention

The invention pertains to apparatus and methods for heat treating materials, and more particularly, for heat treating materials in a fluidized bed using microwave power.

2. Description of Related Art

In the heat treatment of materials, various methods have been used to transfer heat from a heat source to the workpiece, including radiation, convection, immersion in a hot liquid, and immersion in a heated bed of fluidized powder. Fluidized bed systems have the following attributes: uniform heating, relatively fast, simple changeover to different conditions, and low capital and operating costs. The bed of inert material, typically alumina and silica sand type compounds, may be fluidized by either a non oxidizing gas, e.g. nitrogen, or an oxidizing gas such as air. The bed is non-corrosive, non-toxic, and non-abrasive. In operation, the bed behaves like a well stirred liquid so heat is rapidly distributed throughout the work zone. This provides excellent temperature uniformity, which gives consistent performance and minimizes reject components.

One limitation of fluidized bed systems is that they tend to have a long cycle time. For example, a system configured to heat treat 45 kg of metal parts to 925° C. has a total cycle time of 7.5 hours from loading to cooldown. The traditional fluidized bed heat treating system has an initial heat up cycle from ambient conditions prior to placing material in the bed for heat treating. The initial heat up time is 4 hours. Once the bed is at temperature, the chamber is opened and the material to be heat treated is added. Reheat time to recover the heat lost during loading and to heat the parts inserted is 3.5 hours. Additional materials can be added once the initial components are removed reducing the second cycle to the reheat duration of 3.5 hours. Insulating the bed contributes to retaining the heat, which in turn reduces the reheat time if subsequent use is not immediately required.

The use of microwave energy to heat various materials is well known in the art. Cooking and drying operations, in which the principal material acted upon is water, are perhaps best known and most widely used. When microwave energy is intended to be used for a high temperature process, such as sintering or heat treatment, various methods have been developed in an attempt to achieve several goals. First, insulating caskets are often placed within a cold-wall microwave cavity in order to localize the high temperatures to a small volume surrounding the workpiece, as taught for example, by Holcombe et al. in U.S. Pat. No. 4,810,846, and by Lauf et al. in U.S. Pat. No. 5,184,286. Second, because many metals and ceramics don't absorb microwave energy efficiently when cold, susceptor materials such as boron carbide or silicon carbide are commonly placed within the caskets as taught, for example, by Holcombe in U.S. Pat. No. 4,559,429.

### OBJECTS AND ADVANTAGES

Objects of the present invention include the following: providing an improved heat treating apparatus and method having shorter cycle time; providing a more efficient fluidized bed reactor; providing an improved apparatus for heat treating metallic components; providing improved heat transfer media for a fluidized bed reactor; providing a more efficient system for heating metal components with microwave energy; and, providing a heat treating system that significantly reduces the related facility's infrastructure when compared to existing heat treatment technologies. These and other objects and advantages of the invention will become apparent from consideration of the following specification, read in conjunction with the drawings.

### SUMMARY OF THE INVENTION

According to one aspect of the invention, a heat treating system comprises:

a microwave applicator cavity, the cavity having a gas-diffusing inlet structure on one surface thereof and a gas outlet on another surface thereof;

a microwave power supply;

a transmission line between the applicator cavity and the power supply; and,

a fluidizable granular heat transfer medium partially filling the cavity.

According to another aspect of the invention, a method for heat treating selected materials, comprises the steps of:

placing a material to be heated into a microwave applicator cavity, the cavity having a gas diffusing inlet structure on one surface thereof and a gas outlet on another surface thereof;

partially filling the cavity with a quantity of granular heat transfer medium sufficient to cover the material to be treated and to cover the gas diffusing structure;

flowing a gas through the diffusing structure at a rate sufficient to fluidize the granular medium; and,

introducing microwave energy into the cavity to raise the material and the granular medium to a selected temperature for a selected time.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of a prior cold-wall microwave cavity having an insulated casket and workpiece therein.

FIG. 2 is a schematic diagram in cross section of one example of the hot-wall microwave cavity of the present invention.

FIG. 3 is a schematic diagram of an example of the present invention illustrating the major components of the system.

FIG. 4 is a schematic diagram of various launch configurations for use in the present invention. FIG. 4A shows a waveguide entering the cavity from the top. FIG. 4B shows a waveguide entering an enlarged transition at the top of the cavity. FIG. 4C shows a waveguide entering the cavity from the side at a 90° angle. FIG. 4D shows a waveguide entering the cavity from the side but at an oblique angle. FIG. 4E shows a waveguide entering the cavity at an oblique angle with a deflecting structure added at the entry point. FIG. 4F shows a waveguide entering at a perpendicular angle to the cavity at a point within the granular zone, with a quartz window to prevent granular material from entering the waveguide.

FIG. 5 is a schematic diagram of modifications to the microwave launch structure suitable for use in the present invention in which the waveguide enters the cavity axially from the bottom and a suscepting structure is provided to prevent granular material from entering the waveguide. FIG. 5A shows a generally cylindrical suscepting structure clamped to the diffuser plate. FIG. 5B shows a generally conical susceptor structure clamped to the diffuser plate.

### DETAILED DESCRIPTION OF THE INVENTION

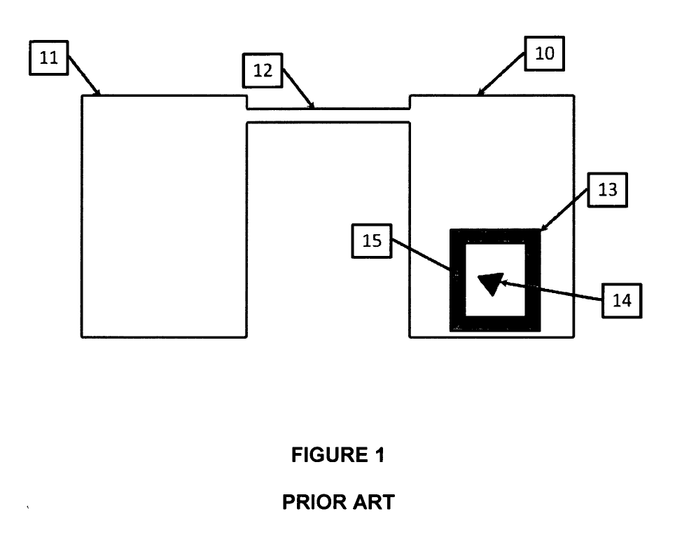

In general terms, the inventive heat treating system is characterized by a hot-wall applicator cavity, which eliminates the need for casketing used in the cold-wall applicators of the prior art (as shown for example, in FIG. 1). This aspect greatly simplifies loading and unloading and increases throughput considerably. The microwave applicator cavity therefore doubles as the process crucible and contains the charge of material (or workpiece) to be treated along with a granular heat transfer medium. The cavity may be of any desired shape and size, and has a gas-diffusing structure on one surface; gas flowing through this structure fluidizes the granular medium that surrounds the workpiece.

A microwave power supply, preferably operating on one of the ISM bands (e.g., 2.45 GHz, 900 MHz, 450 MHz, etc.) is connected to the cavity using any conventional transmission line. A waveguide connected to at least one launcher on the cavity is particularly suitable.

The granular heat transfer medium generally consists of one or more types of ceramic grains or particles, selected on the basis of the particulars of the process (temperature, gas composition, workpiece composition, etc.) The granules may all be substantially the same material or they might consist of several types of materials if the user wants to tailor the dielectric properties of the medium. For example, a medium consisting of a mixture of alumina particles and silicon carbide particles will be more absorbent of microwave energy than a bed of pure alumina. Particle or granule size may be any suitable range that will be small enough to be adequately fluidized by the selected gas flow but not so fine as to be ejected from the system or entrained in the outflowing gas stream. It will be appreciated that if particles of two different compositions are used, the relative particle sizes of the two materials will preferably be selected based on their respective densities so that each material has a comparable aerodynamic buoyancy. Proper sizing of the two phases will prevent the bed from stratifying, which might occur if the two phases have different buoyancies.

The invention is generally used in the following way. The applicator cavity is opened and the material or workpiece(s) to be heat treated is placed in the cavity along with sufficient granular medium to cover the material. It will be appreciated that the total volume of the charge will be smaller than the overall volume of the cavity, so that some headspace remains to allow for the bed to be fluidized properly. The cavity is closed and microwave power is applied to heat the bed to the desired temperature. After the desired time-temperature profile has been applied, microwave power is discontinued, the charge is removed and quenched (as desired) and a new charge is placed in the cavity.

In order to improve the energy efficiency of the system, the hot-wall applicator is preferably enclosed in a cabinet that is lined with insulation. Various ancillary devices and systems such as temperature measurement and controls, gas handling or recirculating equipment, windows, viewing ports, video cameras, etc., may be provided as described in more details in the examples that follow.

### Example

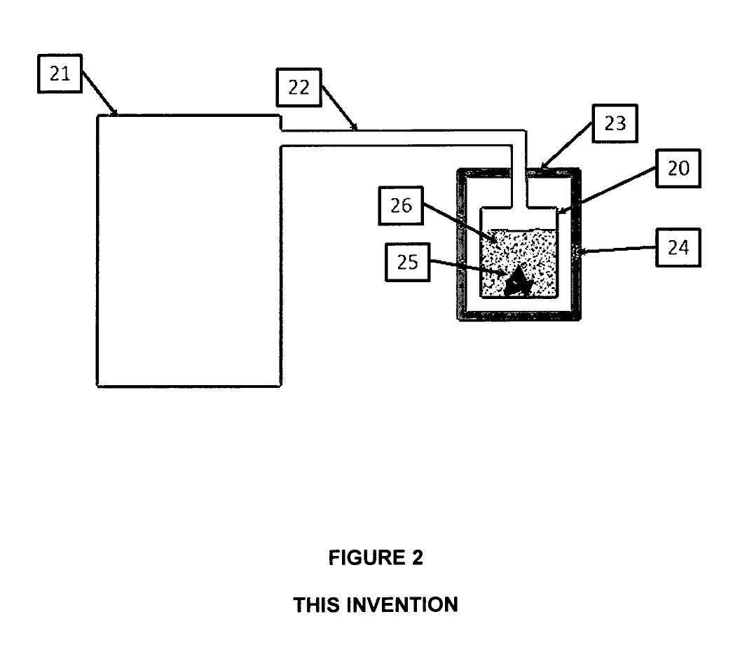

The basic configuration of the inventive system is shown schematically in FIG. 2. A hot-wall cavity 20 receives power from a microwave generator 21 via waveguide 22. The hot-wall cavity 20 is contained within a protective cabinet 23, which is preferably lined with insulation 24. Components to be heat treated 25 are immersed in a granular medium 26.

Comparing the invention to a conventional system for high temperature microwave treatment, shown schematically in FIG. 1, there are several clear differences. In the prior art, a cold-wall cavity 10 receives power from microwave generator 11 via waveguide 12. An insulated casket 13 is placed inside the cold-wall cavity 10 and contains the workpiece 14, insulation 15, and any microwave-suscepting materials as taught, e.g., by Holcombe et al. in U.S. Pat. No. 4,810,846. It will be appreciated that for each run in the prior art system, the cavity must be opened, then the inner casket must be at least partially disassembled and the workpiece(s) removed. New workpiece(s) are placed in the casket and the casket is rebuilt, the cavity is then closed, and the system is ready to heat.

A further shortcoming of prior systems is that temperature measurement is extremely cumbersome. Insulated, protected thermocouples are typically inserted into the casket as the workpieces are added, and the thermocouples are connected via cables that penetrate the microwave cavity to bring the output to an external measurement and control system. The multiple layers of sheathing needed to protect the thermocouples from the microwave energy inherently interfere with accurate temperature measurement. In the inventive system, by contrast, thermocouples (or optical measurements) may be used directly on the wall of the applicator cavity, which is now at about the same temperature as the fluidized bed contained therein.

Another shortcoming of prior systems is that they don't lend themselves to fluidized bed heat treatment methods.

Those skilled in the art will appreciate that the inventive design represents a radical departure from conventional microwave applicators, in having a hot-wall cavity. Traditionally, the applicator walls are kept cool, not only for safety and general convenience, but also because the electrical characteristics of the cavity are affected by the conductivity of the cavity wall. As the electrical resistance of the wall increases (as it does when the wall gets hot), more power is dissipated in the wall as opposed to heating the workpiece directly. In conventional heating or cooking, this would lead to significant inefficiencies. However, in the inventive fluidized bed system, with insulation placed outside the cavity, heat generated in the cavity walls is not lost, but instead contributes to heating the workpiece and the granular bed. Thus, the inventive applicator cavity doubles as the process crucible, and because it is preferably contained within an insulated cabinet, the walls of the cavity are substantially isothermal with the heat transfer medium and the workpiece

### Example

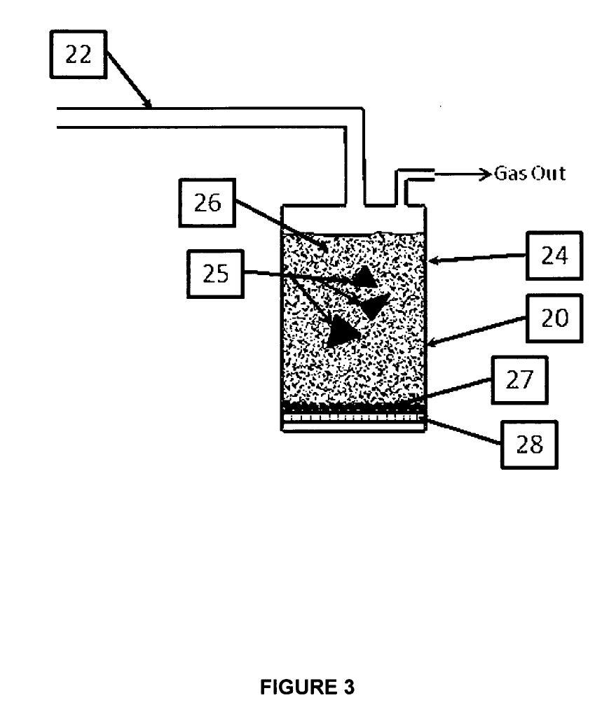

A system was constructed as generally shown in FIG. 3. An applicator 20 (20 cm diameter and 90 cm tall) was fabricated from an austenitic stainless steel alloy and oriented vertically. Gas was introduced from the bottom. Microwave power was supplied by a magnetron 21 capable of providing 6 kW at 2.45 GHz, and connected to the applicator 20 through a conventional waveguide 22. In one test, the system was charged with ˜13.6 kg of SiC granules 26 (60 mesh) and ˜4 kg of metal components of random sizes and shapes 25. The charge was heated to ˜930° C. in about 2.5 hours.

To place the foregoing results in perspective, a comparable run using conventional (resistance-heated) fluidized bed equipment would typically require 7.5 hours.

The inventive system can be adapted to various heat treatment problems, including, but not limited to: annealing, stress relief, normalizing, aging, nitriding, carburizing, nitrocarburizing, carbonitriding, oxidizing, neutral hardening and other heating and surface treatment processes.

The granular heat transfer medium may be a single material or it may be a mixture of materials, depending on the desired properties and the composition of the workpiece and the process gas. In particular, for some applications, the medium might be substantially transparent to microwave energy whereas in others it might be somewhat absorbent. It will further be understood that the dielectric properties of typical ceramic granules such as alumina, zirconia, zircon, silicon carbide, boron carbide, carbon, etc., are strongly temperature dependent. Thus, the operator has wide latitude to optimize the process for particular materials and objectives by the selection of particular heat transfer media through routine experimentation. The primary requirement is that the medium must be generally stable in the process atmosphere at the process temperature.

A number of tests have been conducted using a) various combinations of granular materials and b) methods to evaluate and select the optimal pathway for directing the microwave energy to the granular materials. Fluidic testing of multiple compound granulars illustrated that optimal selections are based upon granular densities as well as individual granular sizes to preclude granular component stratification. Different granular mixes were tested to illustrate uniformity and self-limiting upper temperature potential at the end of a defined time period. Selection of mixed granulars is dependent upon the fluidization gas to ensure prevention of interactive by-products that could lead to clumping, lumping or transition of the granular components that may attack the objects being heat treated.

### Example

The following table summarizes the various combinations of media that were tested.

Test Runs and Composition of Granular Medium

| Medium | % Al₂O₃ | % SiC |
|---|---|---|
| 1 | 50 | 50 |
| 2 | 40 | 60 |
| 3 | 0 | 100 |

### Example

The first run contained a mixture of Al₂O₃ and SiC as noted above. It was observed that the material didn't heat as quickly as expected. The amount of Al₂O₃ was adjusted on subsequent runs to determine if faster heating times could be obtained and thus reduce the cycle time and the amount of energy required to complete the run. The test data supported the theory for increasing the suscepting materials (SiC) in order to obtain faster heating times and less overall energy consumption. This is not to say temperature self-limiting bed mixes are not desired, however, the test results demonstrate that same results may be obtained by implementing power adjustments of the microwave generator(s) during a given run.
In an effort to further reduce the amount of energy consumption and to decrease the heating cycle times, a heat recovery device was added to the gas outlet to transfer the heat from the process gas to the compressed gas introduced to fluidize the granular material in the bed. The device consisted of a simple gas-to-gas heat exchanger as is well known in the art. It will be understood that the heat exchanger may be of any conventional design suitable for accommodating the temperature of the outgoing process gas; in many cases a counterflow design will provide the greatest heat recovery potential.
The use of a heat recovery device enhanced the energy recovery, which yields energy savings and faster heating rates.

Those skilled in the art will appreciate the utility of a fluidized bed heat transfer medium that inherently allows the process to be self-limiting or self-controlling to a desired processing temperature.

### Example

Mixing different granular components together with varying particle sizes generally leads to stratification of the larger particles under the smaller particles during bed fluidization. The user may therefore conduct simple tests of all granular particles of a particular size to determine density, aerodynamics based on shape and surface characteristics and the ability of the particle to carry and transfer the heat to the heat treated component. It will be appreciated that to prevent stratification of the bed, all materials in the particle mix should have equivalent aerodynamic densities, i.e., particles of a higher density material will in general be smaller than those of a lower density material so that both materials have comparable fluidization behavior. Larger particle sizes in the fluidization bed require larger fluidization gas volumes at higher delivery pressures to turn-over the particles and fluidize the overall bed. In some cases, stratification can be used to advantage. For instance, much larger particles 27 may be used to insulate the diffuser plate 28 located in the bottom of the fluidization cavity. Because of their inherently larger aerodynamic density, these particles will stay on the bottom of the bed rather than becoming dispersed throughout the bed.

It is well known in the art of microwave heating that in an applicator of fixed size and a microwave source operating at constant frequency, the placement of the microwave launcher or launchers within the cavity can have a significant effect on the distribution of power within the cavity. Consequently, a number of configurations were tested, using both single- and multiple-launch designs.

### Example

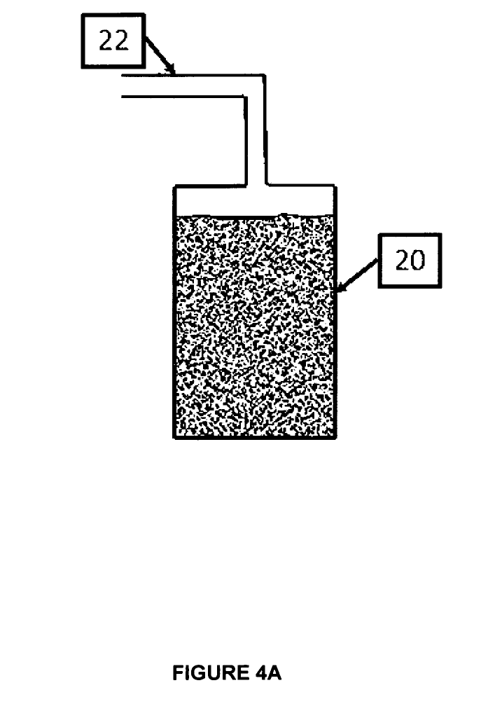

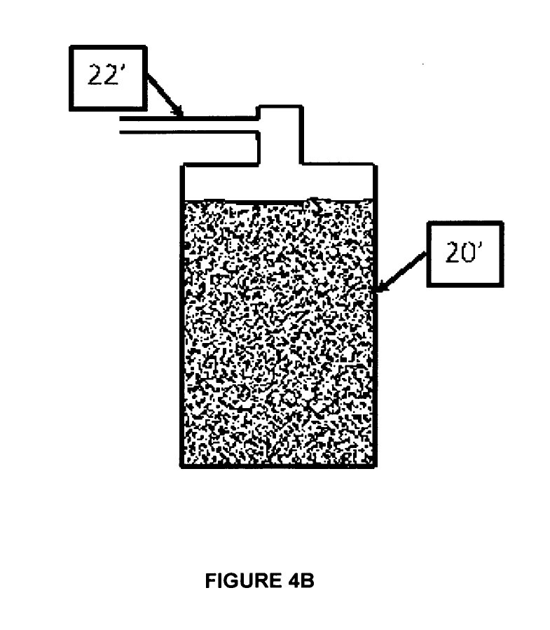

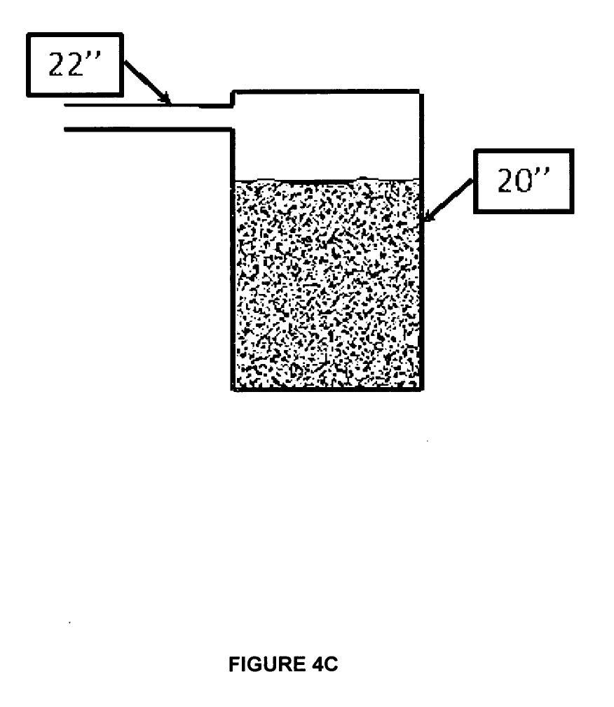

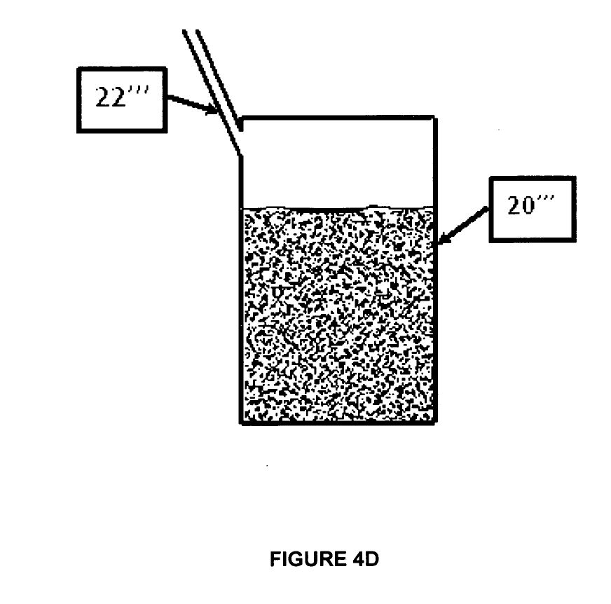

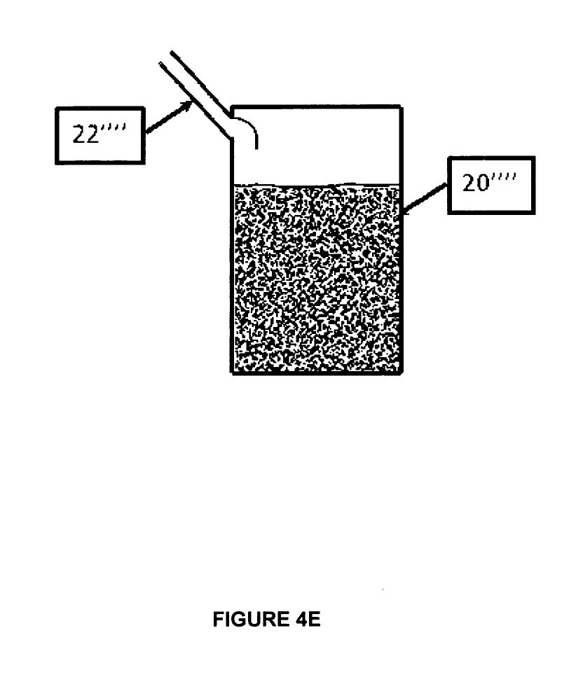

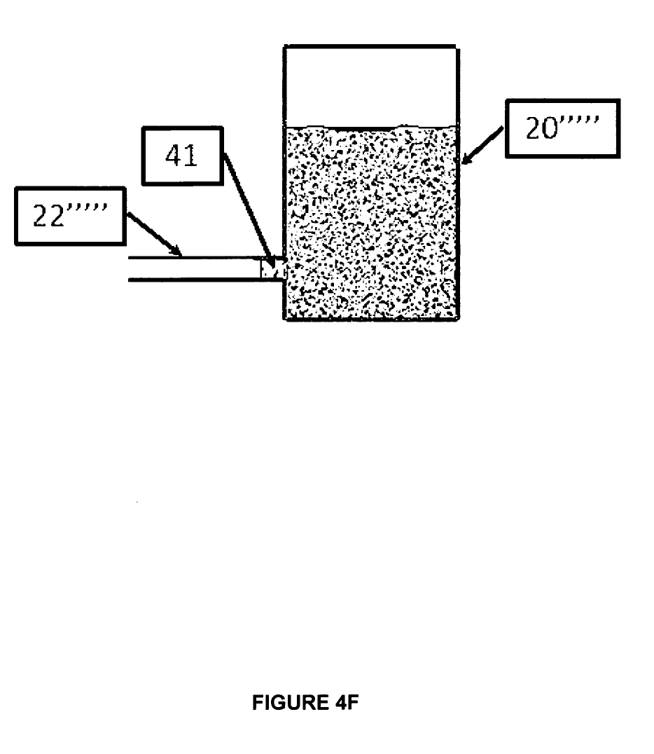

Launcher geometries evaluations include bottom, side within the granular bed zone, side above the granular bed zone, and top, as shown schematically in FIG. 4. Each launcher location investigated also was introduced into the granular bed zone at different angles that included perpendicular, tangential and oblique. Configurations that were within the granular bed zone also included isolation components such as quartz glass window 41, suscepting or non-suscepting shapes and disks such as components manufactured from silicon carbide (relatively suscepting) and alumina (relatively non-suscepting).

### Example

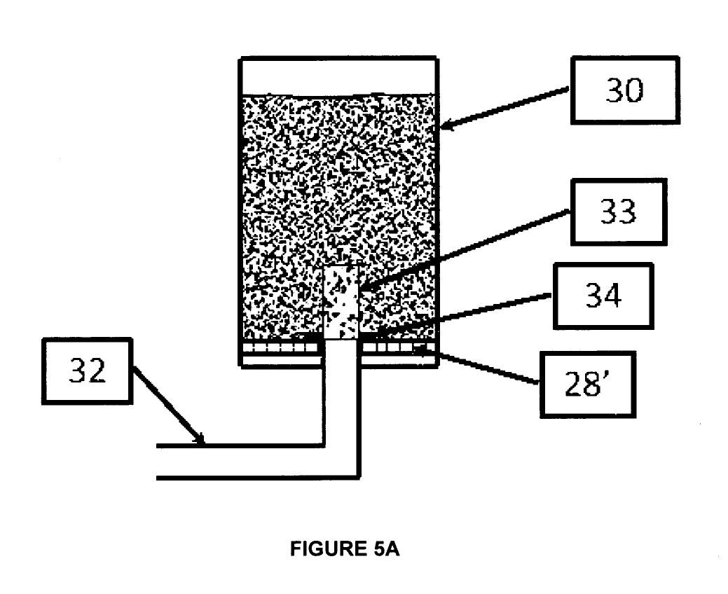

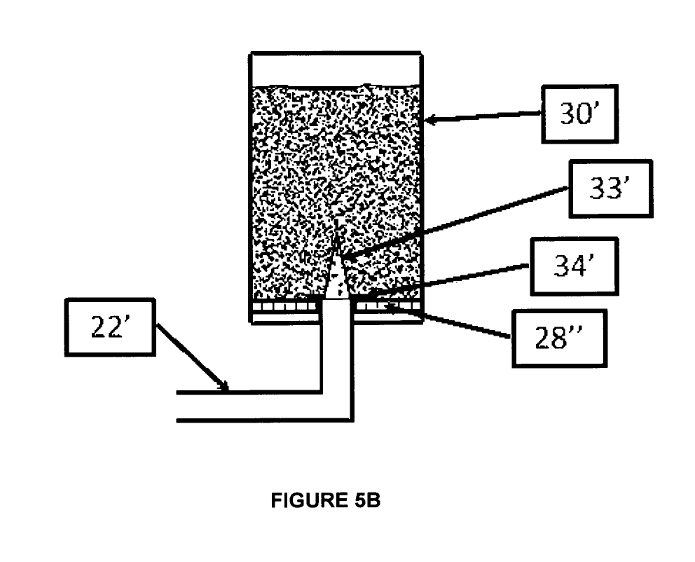

As described in the preceding example, several variants were developed and tested with regards to suscepting and non-suscepting components, geometries, and placement in the waveguide terminations to the granular bed materials, as shown schematically in FIGS. 5A-B. The use of the suscepting cone 33, 33′ provided a method of heating the granular material by conduction, convection, and radiation methods in the bottom of the granular material bed 26. The cone shape allows the granular material to flow down the surface of the cone and prevents the holdup of any granular material due to its inherent shape. In one case, the cone 33′ was fitted to the center of the diffuser plate 28′ and clamped in place by pressure plates 34. Other shapes patterned after right circular cylinders 33 were designed but not tested.

In any fluidized bed system, it is important to control the flow of gas and granular medium at the point where gas is introduced, typically through a diffuser plate or similar structure. Conventional (i.e., non-microwave) fluidized bed heating systems typically manage these processes by the following approach. The fluidized bed furnaces may comprise a container that contains a finely divided particulate heat transfer medium such as aluminum oxide as taught by Staffin in U.S. Pat. No. 4,512,821. As described therein, a distributor plate is positioned at the bottom of the container for introducing the fluidizing gas up through the bed medium. The distributor plate is thermally protected by a layer of larger particles that serve to insulate the plate from the granular fluidized bed above. The layer of larger particles fully supports the smaller particle granular fluidized bed. The fluidizing gas expands and suspends the granular particles and transmits heat from electric or gas heaters. Any item placed in the fluidized medium is uniformly and rapidly heated.

We claim:

1. A heat treating system comprising:
a microwave applicator cavity, said cavity having a gas-diffusing inlet structure on one surface thereof and a gas outlet on another surface thereof;
a microwave power supply;
a transmission line between said applicator cavity and said power supply; and,
a fluidizable granular heat transfer medium partially filling said cavity.

2. The system of claim 1 wherein said applicator cavity comprises a right circular cylinder oriented vertically and said gas diffusing inlet structure is on the bottom surface of said cylinder.

3. The system of claim 1 wherein said microwave power supply operates on an ISM frequency band and said transmission line comprises a waveguide.

4. The system of claim 1 wherein said granular heat transfer medium comprises a ceramic powder that is at least partially transparent to microwave energy.

5. The system of claim 1 wherein said granular heat transfer medium is selected from the group consisting of: alumina, zirconia, zircon, carbon, silicon, silicon carbide, boron carbide, and other carbide based materials.

6. The system of claim 1 wherein said granular heat treatment medium comprises a first granular phase having a first dielectric loss and a second granular phase having a second dielectric loss greater than that of said first phase.

7. The system of claim 1 wherein the particle sizes of said first and second granular phases are selected so that said first and second phases have substantially equivalent aerodynamic buoyancies.

8. The system of claim 1 further comprising a volume of granules that are too large to become fluidized during operation, said large granules forming a protective layer on top of said inlet structure.

9. The system of claim 3 wherein said waveguide further comprises a termination structure selected from the group consisting of: flat ceramic windows; conical ceramic windows; and cylindrical ceramic windows.

10. The system of claim 1 wherein the dielectric properties of said granular heat transfer medium vary with temperature so that microwave heating of said medium is at least partially self-limiting.

11. The system of claim 1 further comprising an insulated cabinet enclosing said microwave applicator cavity.

12. A method for heat treating selected materials, comprising the steps of:
placing a material to be heated into a microwave applicator cavity, said cavity having a gas diffusing inlet structure on one surface thereof and a gas outlet on another surface thereof;
partially filling said cavity with a quantity of granular heat transfer medium sufficient to cover said material to be treated and to cover said gas diffusing structure;
flowing a gas through said diffusing structure at a rate sufficient to fluidize said granular medium; and,
introducing microwave energy into said cavity to raise said material and said granular medium to a selected temperature for a selected time.

13. The method of claim 12 wherein said applicator cavity comprises a right circular cylinder oriented vertically and said gas diffusing inlet structure is on the bottom surface of said cylinder.

14. The method of claim 12 wherein said granular heat transfer medium comprises a ceramic powder that is at least partially transparent to microwave energy.

15. The method of claim 12 wherein said granular heat transfer medium is selected from the group consisting of: alumina, zirconia, zircon, carbon, silicon, silicon carbide, boron carbide, and other carbide based materials.

16. The method of claim 12 wherein said granular heat treatment medium comprises a first granular phase having a first dielectric loss and a second granular phase having a second dielectric loss greater than said first phase.

17. The method of claim 12 wherein the particle sizes of said first and second granular phases are selected so that said first and second phases have substantially equivalent aerodynamic buoyancies.

18. The method of claim 12 wherein the dielectric properties of said granular heat transfer medium vary with temperature so that microwave heating of said medium is at least partially self-limiting.
